(19) United States
(12) Patent Application Publication
(10) Pub. No.: US 2026/0214463 A1
(43) Pub. Date: Jul. 23, 2026

(54) RADIO ZONE DESIGN APPARATUS, RADIO ZONE DESIGN METHOD, AND PROGRAM

(71) Applicant: NTT, Inc., Tokyo (JP)

(72) Inventors: Toshiro NAKAHIRA, Tokyo (JP); Daisuke MURAYAMA, Tokyo (JP); Motoharu SASAKI, Tokyo (JP); So TAKATANI, Tokyo (JP); Takatsune MORIYAMA, Tokyo (JP)

(21) Appl. No.: 18/865,517

(22) PCT Filed: Jun. 30, 2022
(86) PCT No.: PCT/JP2022/026403

§ 371 Date: Nov. 13, 2024

(51) Int. Cl. H04W 16/18; H04W 8/22

(52) U.S. Cl. CPC H04W 16/18; H04W 8/22

(57) ABSTRACT

A radio zone design apparatus includes a processor for executing a process including arranging terminal positions and candidate positions for an installation position of a base station or a relay station in the wireless area including a shielding object; calculating reception power between each of the terminal positions and a corresponding one of the candidate positions, and reception power between each of the candidate positions and a corresponding one of other candidate positions; selecting, for each of different numbers of base stations, a candidate position of the base station for a corresponding number of base stations; selecting a candidate position of the relay station capable of accommodating, in combination with the candidate position of the base station, the terminal position that is not able to be accommodated; and determining installation positions of the base station and the relay station in which a cost of the wireless area is minimized.

### TECHNICAL FIELD

The present invention relates to a radio zone design apparatus, a radio zone design method, and a program.

### BACKGROUND ART

A radio zone design apparatus is known for designing an appropriate installation position of a wireless base station for constructing a wireless area. In addition, with the increasing use of high frequency bands in wireless communication systems, the influence of attenuation and shielding increases, and technical studies have been conducted on radio zone design method utilizing a relay station (repeater, relay terminal, and the like).

For example, Non Patent Literature 1 proposes a radio zone design method for improving communication quality of a user by appropriate arrangement in a case where a certain number of relay stations can be placed in an arbitrary environment. In addition, Non Patent Literature 2 proposes a method for appropriately determining a position of a relay communication terminal and an orientation of an antenna.

### CITATION LIST

### Non Patent Literature

Non Patent Literature 1: Yoneda et al., “AF Relay Station Deployment Method Considering Uniform Coverage and Blocking in MmWave Cellular Systems”, IEICE Technical Report, vol. 121, no.391, RCS2021-290, pp. 189-194, March 2022 Non Patent Literature 2: Fujio et al., “A Study of Relay Radio zone design method for Mobile Relay Systems” The Institute of Electronics, Information and Communication Engineers (IEICE) General Conference, B-5-25, March 2022

### SUMMARY OF INVENTION

### Technical Problem

In the conventional technique, radio zone design method of a relay station with respect to an already arranged base station has been studied, but it is not possible to perform radio zone design method satisfying a necessary communication request at low cost by combining the base station and the relay station.

Embodiments of the present invention have been made in view of the above problem, and it is enabled to perform radio zone design method satisfying a necessary communication request at low cost by combining the base station and the relay station.

### Solution to Problem

In order to solve the above problem, a radio zone design apparatus according to an embodiment of the present invention is a radio zone design apparatus for designing installation positions of a base station and a relay station for constructing a wireless area, and includes: an arrangement unit configured to arrange a plurality of terminal positions and a plurality of candidate positions, the plurality of terminal positions being evaluation points, and the plurality of candidate positions being candidates for an installation position of the base station or the relay station in the wireless area including a shielding object; a calculation unit configured to calculate reception power between each of the terminal positions and a corresponding one of the candidate positions, and reception power between each of the candidate positions and a corresponding one of other candidate positions; a first selection unit configured to select, for each of different numbers of base stations, a candidate position of the base station for a corresponding number of base stations from among the plurality of candidate positions; a second selection unit configured to select, in a case where there is a terminal position that is not able to be accommodated by the candidate position of the base station among the plurality of terminal positions, a candidate position of the relay station capable of accommodating, in combination with the candidate position of the base station, the terminal position that is not able to be accommodated; and a determination unit configured to determine installation positions of the base station and the relay station in which a cost of the wireless area is minimized from among candidate positions of the base station or combinations of the candidate position of the base station and the candidate position of the relay station.

### Advantageous Effects of Invention

According to the embodiment of the present invention, it becomes possible to perform radio zone design method satisfying a necessary communication request at low cost by combining the base station and the relay station.

### BRIEF DESCRIPTION OF DRAWINGS

FIG. 1 is a diagram illustrating a configuration example of a radio zone design apparatus according to a present embodiment.

FIG. 2 is a flowchart illustrating an example of radio zone design method processing according to the present embodiment.

FIG. 3 is a diagram (1) for explaining the radio zone design method processing according to the present embodiment.

FIG. 4 is a diagram (2) for explaining the radio zone design method processing according to the present embodiment.

FIG. 5 is a diagram (3) for explaining the radio zone design method processing according to the present embodiment.

FIG. 6 is a diagram illustrating an example of an evaluation list according to the present embodiment.

FIG. 7 is a flowchart illustrating an example of first selection processing according to Example 1.

FIG. 8 is a flowchart illustrating an example of the first selection processing according to Example 2.

FIG. 9 is a diagram illustrating an example of a hardware configuration of the radio zone design apparatus according to the present embodiment.

### DESCRIPTION OF EMBODIMENTS

An embodiment of the present invention (present embodiment) will be described below with reference to the drawings. The embodiment to be described below is merely an example, and embodiments to which the present invention is applied are not limited to the following embodiment.

### Configuration Example of Radio Zone Design Apparatus

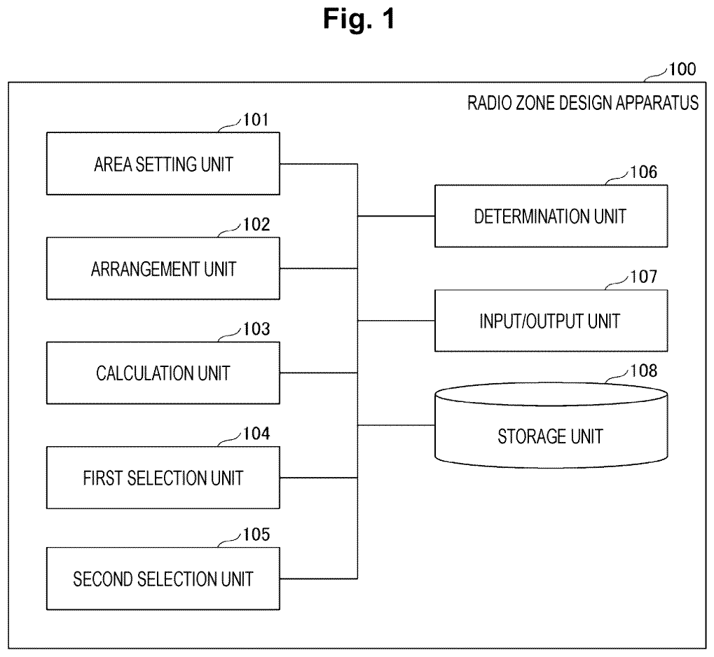

FIG. 1 is a diagram illustrating a configuration example of a radio zone design apparatus according to the present embodiment. A radio zone design apparatus 100 is an information processing device having a configuration of a computer or a system including a plurality of computers. The radio zone design apparatus 100 performs radio zone design method of designing installation positions of a base station and a relay station for constructing a wireless area.

In the radio zone design apparatus 100, for example, a computer included in the radio zone design apparatus 100 executes a program stored in a storage medium or the like, thereby implementing an area setting unit 101, an arrangement unit 102, a calculation unit 103, a first selection unit 104, a second selection unit 105, a determination unit 106, an input/output unit 107, and the like. Note that at least some of the functional components described above may be implemented by hardware. In addition, the radio zone design apparatus 100 implements the storage unit 108 by, for example, a storage device of the computer included in the radio zone design apparatus 100.

The area setting unit 101 sets a wireless area to be designed. The wireless area to be designed includes, for example, an object such as a wall, a desk, or a shelf serving as a shielding object. For example, the area setting unit 101 may set the wireless area to be designed on the basis of a building database (DB) representing structure of a building, three-dimensional computer aided design (CAD), or the like. Alternatively, the area setting unit 101 may set the wireless area to be designed on the basis of three-dimensional data or the like acquired by Light Detection And Ranging (or Laser Imaging Detection And Ranging) (LiDAR) or a three-dimensional sensor such as a depth camera.

The arrangement unit 102 executes arrangement processing of arranging a plurality of terminal positions that are evaluation points for evaluating reception power and a plurality of candidate positions that are candidates for an installation position of a wireless station (base station or relay station), in the wireless area to be designed.

The calculation unit 103 executes calculation processing of calculating reception power between each of the terminal positions and a corresponding one of the candidate positions arranged by the arrangement unit 102 and reception power between each of the candidate positions and a corresponding one of other candidate positions. For example, the calculation unit 103 calculates reception power received from each candidate position at each terminal position by using a radio wave propagation simulation technique such as ray trace. In addition, in the present embodiment, reception power received from each of the other candidate positions is further calculated at each candidate position.

The first selection unit 104 executes first selection processing of selecting a candidate position of the base station for the number of base stations n from among the plurality of candidate positions for each of different numbers of base stations n (for example, n=1 to N, and N is an integer greater than or equal to 2). For example, the first selection unit 104 divides the plurality of terminal positions arranged by the arrangement unit 102 into clusters of the number of base stations n, and selects, for each of the divided clusters, the candidate position of the base station in which more terminal positions satisfy a predetermined communication quality (for example, reception power). Alternatively, the first selection unit 104 selects, by a greedy algorithm, the candidate position of the base station in order from a candidate position of the base station in which more terminal positions satisfy a predetermined communication quality until the number of base stations n is reached.

In a case where there is a terminal position that cannot be accommodated by the candidate position of the base station selected by the first selection unit 104 among the plurality of terminal positions, the second selection unit 105 executes second selection processing of selecting a candidate position of the relay station capable of accommodating, in combination with the candidate position of the base station, the terminal position that cannot be accommodated. For example, the second selection unit 105 extracts the candidate position of the relay station capable of accommodating the terminal position that cannot be accommodated from among candidate positions excluding the candidate position of the base station selected by the first selection unit 104 among the plurality of candidate positions arranged by the arrangement unit 102. In addition, the second selection unit 105 selects, from among extracted candidate positions of the relay station, a candidate position of the relay station in which reception power from the candidate position of the base station selected by the first selection unit 104 is greater than or equal to a predetermined value.

The determination unit 106 executes determination processing of determining installation positions of the base station and the relay station in which a cost of the wireless area to be designed is minimized from among the above-described candidate positions of the base station or combinations of the candidate position of the base station and the candidate position of the relay station.

The input/output unit 107 executes, for example, output processing of outputting the installation positions of the base station and the relay station determined by the determination unit 106 to an external device, input processing of receiving an input of design conditions and the like from the external device, and the like.

The storage unit 108 stores, for example, data of the wireless area set by the area setting unit 101, data of the plurality of terminal positions and the plurality of candidate positions arranged by the arrangement unit 102, data of the reception power calculated by the calculation unit 103, and the like. In addition, the storage unit 108 stores the candidate position of the base station selected by the first selection unit 104, the candidate position of the relay station selected by the second selection unit 105, and the like.

Note that the functional configuration of the radio zone design apparatus 100 illustrated in FIG. 1 is an example. For example, the storage unit 108 may be implemented by a storage server, a cloud service, or the like accessible by the radio zone design apparatus 100 via a communication network. In addition, the functional components of the radio zone design apparatus 100 may be implemented not only by a physical machine (computer), but also by, for example, a program executed by a virtual machine on a cloud. Further, the functional components of the radio zone design apparatus 100 may be provided in a plurality of information processing devices in a distributed manner.

### <Flow of Processing>

Next, a flow of processing will be described of a radio zone design method according to the present embodiment.

### (Radio Zone Design Method Processing)

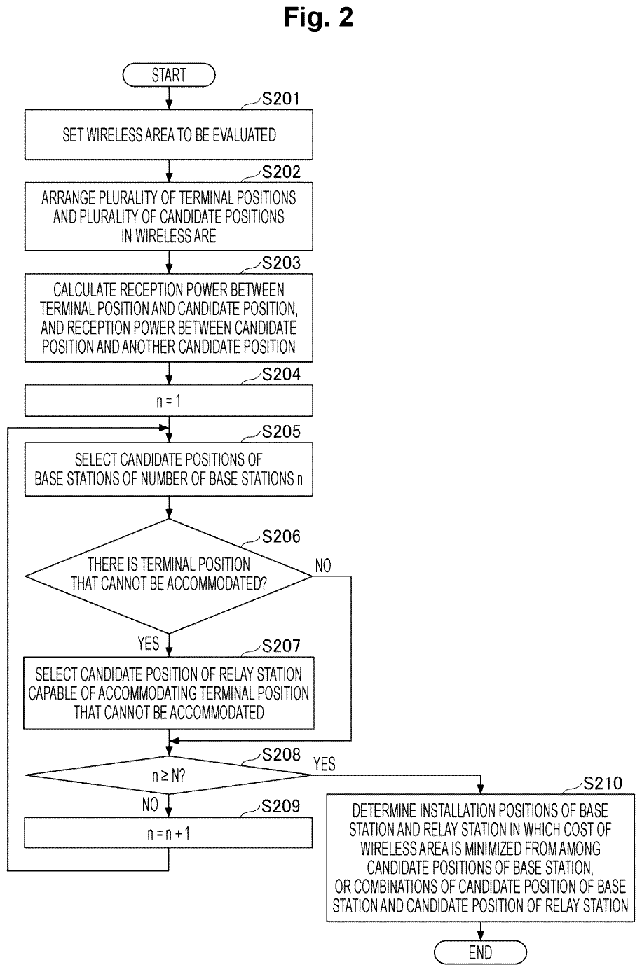

FIG. 2 is a flowchart illustrating an example of radio zone design method processing according to the present embodiment. This processing illustrates, for example, an example of the radio zone design method processing executed by the radio zone design apparatus 100 described with reference to FIG. 1.

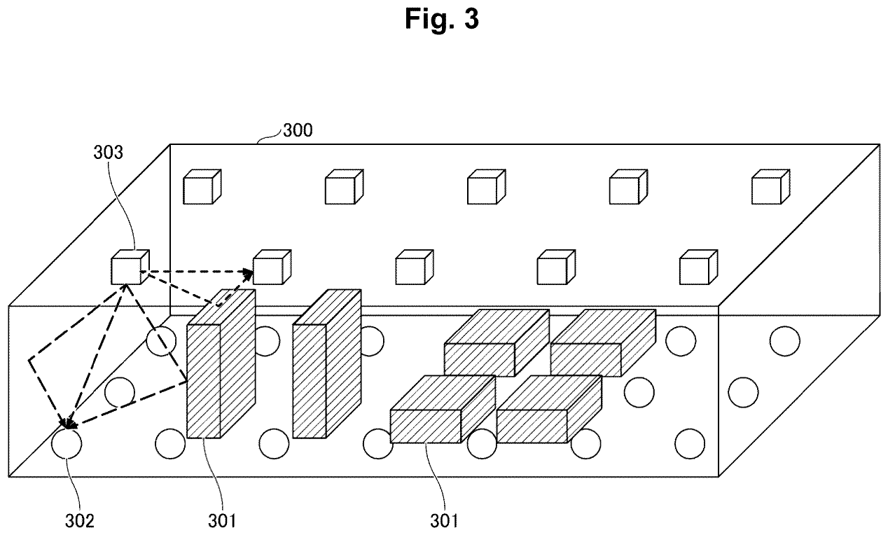

In step S201, the area setting unit 101 of the radio zone design apparatus 100 sets a wireless area to be designed. As an example, as illustrated in FIG. 3, the area setting unit 101 sets a wireless area 300 in an indoor area where a plurality of shielding objects 301 is arranged. Note that the wireless area 300 set by the area setting unit 101 has, for example, three-dimensional coordinates based on three-dimensional CAD data, three-dimensional data acquired by a three-dimensional sensor, or the like.

In step S202, the arrangement unit 102 of the radio zone design apparatus 100 arranges, for example, as illustrated in FIG. 3, a plurality of terminal positions 302 that are evaluation points for evaluating wireless quality such as reception power, in the wireless area 300 set by the area setting unit 101. In addition, the arrangement unit 102 arranges, in the wireless area 300, for example, as illustrated in FIG. 3, a plurality of candidate positions 303 that are candidates for the installation position of the base station or the relay station.

In step S203, the calculation unit 103 of the radio zone design apparatus 100 calculates reception power between a terminal position 302 and a candidate position 303 arranged by the arrangement unit 102, and reception power between a candidate position 303 and another candidate position 303. For example, as illustrated in FIG. 3, the calculation unit 103 calculates the reception power between the terminal position 302 and the candidate position 303 by radio wave propagation simulation such as ray trace. Similarly, the calculation unit 103 calculates reception power for all combinations of the terminal position 302 and the candidate position 303 and of the candidate position 303 and the other candidate position 303. Note that in ray trace, radio waves (rays) transmitted from a transmission point are reflected or diffracted by a structure that is present on the way to a reception point are traced as tracks of the respective rays, and powers of all the rays that have reached the reception point are added up, whereby intensity of the radio waves at the reception point is estimated. Note that ray trace is also referred to as ray tracing.

The base radio zone design apparatus 100 initializes the number of base stations n to 1 in step S204, and executes the processing in and after step S205.

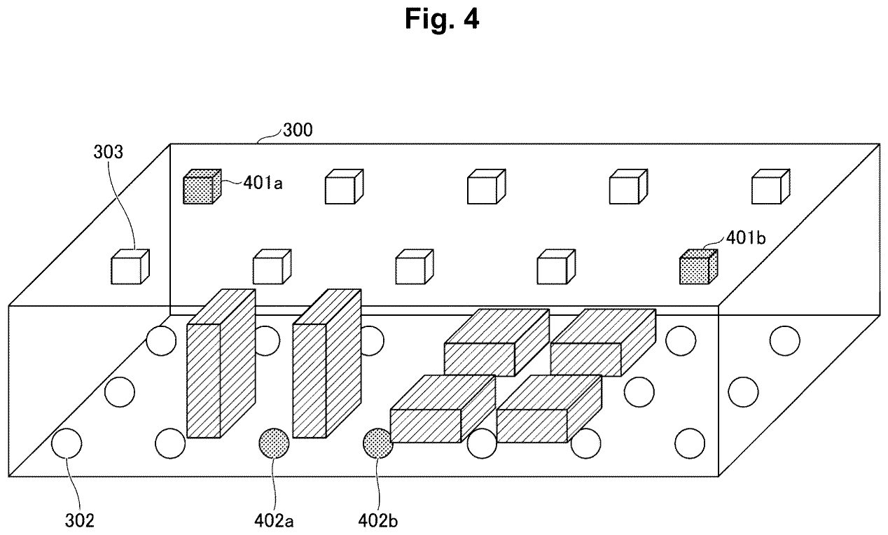

In step S205, the first selection unit 104 of the base radio zone design apparatus 100 selects a candidate position of the base station for the number of base stations n from among the plurality of candidate positions 303. FIG. 4 illustrates an example of a case where the first selection unit 104 selects candidate positions 401a and 401b of two base stations from among the plurality of candidate positions 303 (a case where the number of base stations n is 2). Note that a specific example will be described later of the first selection processing of selecting the candidate position of the base station of the number of base stations n from among the plurality of candidate positions 303 by the first selection unit 104, by exemplifying a plurality of examples.

In step S206, the second selection unit 105 of the radio zone design apparatus 100 determines whether or not there is a terminal position 302 that cannot be accommodated by the base stations selected by the first selection unit 104. For example, in FIG. 4, it is assumed that reception power from the candidate positions 401a and 401b of the base stations selected by the first selection unit 104 is less than or equal to the predetermined value at the terminal positions 402a and 402b. In such a case, the second selection unit 105 determines that there is the terminal position 302 that cannot be accommodated by the base stations selected by the first selection unit 104.

In a case where there is the terminal position 302 that cannot be accommodated, the second selection unit 105 causes the processing to proceed to step S207. On the other hand, in a case where there is no terminal position 302 that cannot be accommodated, the second selection unit 105 causes the processing to proceed to step S208.

When the processing proceeds to step S207, the second selection unit 105 selects a candidate position of the relay station capable of accommodating, in combination with a candidate position of the base station selected by the first selection unit 104, a terminal position that cannot be accommodated.

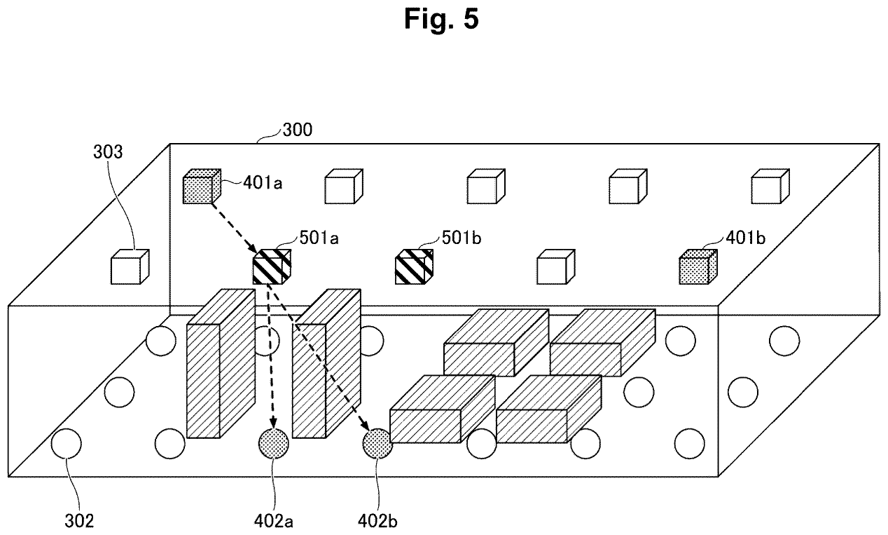

For example, in FIG. 4, it is assumed that the terminal positions 402a and 402b cannot be accommodated by the candidate positions 401a and 401b of the base stations selected by the first selection unit 104 (reception power is less than or equal to the predetermined value). In this case, as illustrated in FIG. 5, the second selection unit 105 extracts candidate positions 501a and 501b capable of accommodating the terminal positions 402a and 402b that cannot be accommodated from among the candidate positions 303 excluding the candidate positions 401a and 401b of the base stations among the plurality of candidate positions 303. In addition, the second selection unit 105 selects, from among the extracted candidate positions 501a and 501b, a candidate position of the relay station (for example, the candidate position 501a of the relay station) in which reception power from the candidate positions 401a and 401b of the base stations selected by the first selection unit 104 is greater than or equal to the predetermined value. Note that, in a case where there is a plurality of candidate positions of the relay station in which the reception power from the candidate positions 401a and 401b of the base stations is greater than or equal to the predetermined value, the second selection unit 105 may select, for example, a candidate position of the relay station in which the reception power from the candidate positions 401a and 401b of the base stations is larger.

When the processing proceeds to step S208, the radio zone design apparatus 100 determines whether or not a value of n is greater than or equal to the maximum value N of the number of base stations that can be arranged in the wireless area 300. In a case where the value of n is greater than or equal to N, the radio zone design apparatus 100 causes the processing to proceed to step S210. On the other hand, in a case where the value of n is not greater than or equal to N, the radio zone design apparatus 100 causes the processing to proceed to step S209. Note that a value of N is set in advance in the radio zone design apparatus 100 by a designer or the like.

When the processing proceeds to step S209, the radio zone design apparatus 100 adds 1 to n, and returns the processing to step S205.

By the processing of steps S204 to S209, the base radio zone design apparatus 100 selects the candidate position of the base station and the candidate position of the relay station for each of different numbers of base stations (numbers of base stations 1, 2, 3, . . . , N).

When the processing proceeds from step S208 to step S210, the determination unit 106 of the base radio zone design apparatus 100 determines installation positions of the base station and the relay station in which a cost of the wireless area 300 is minimized from among candidate positions of the base station or combinations of the candidate position of the base station and the candidate position of the relay station.

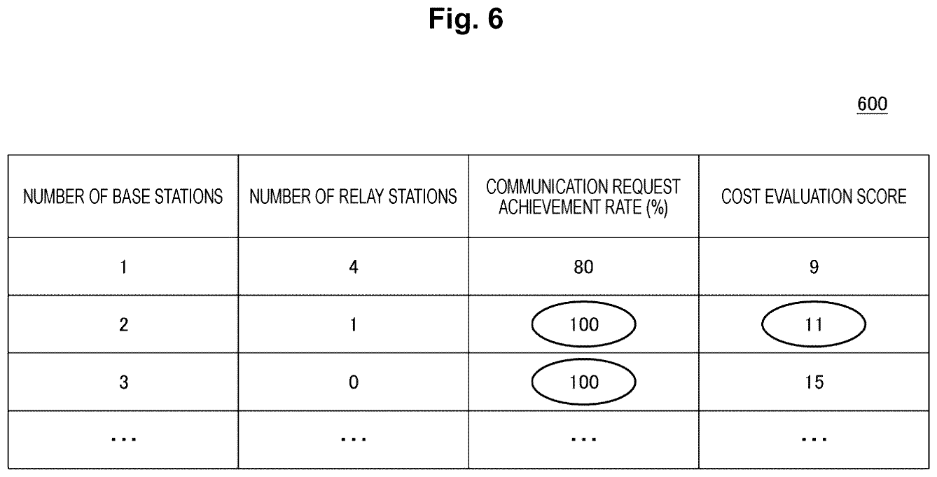

For example, the determination unit 106 compiles evaluation results at the candidate positions of the base station and the relay station selected for each of different numbers of base stations in steps S204 to S209 into an evaluation list 600 as illustrated in FIG. 6. In the example of FIG. 6, the evaluation list 600 includes information such as “number of base stations”, “number of relay stations”, “communication request achievement rate (%)”, and “cost evaluation score” as items.

The “number of base stations” corresponds to the above-described number of base stations n. The “number of relay stations” is, for example, the number of relay stations selected in step S207 in FIG. 2 for each “number of base stations”. The “communication request achievement rate (%)” is, for example, an achievement rate of a communication request corresponding to a combination of the “number of base stations” and the “number of relay stations” (for example, a ratio of the terminal positions 302 that satisfy a communication request among the plurality of terminal positions 302). The “cost evaluation score” is a score for evaluating a cost for constructing the wireless area 300. As an example, in a case where a cost of the base station is five times a cost of the relay station, the determination unit 106 may calculate the cost evaluation score of the wireless area 300 by the following Formula (1).

$$Cost evaluation score = ( the number of base stations \times 5 ) + the number of relay stations$$

In addition, the determination unit 106 determines, from the evaluation list 600, installation positions of the base station and the relay station in which the cost evaluation score of the wireless area 300 is minimized while satisfying the communication request achievement rate necessary for the wireless area 300. For example, in the evaluation list 600 illustrated in FIG. 6, it is assumed that the communication request achievement rate required in the wireless area 300 is 100%. In this case, the determination unit 106 determines, as arrangement positions of the base station and the relay station, the candidate positions of the base station and the relay station in a case where the number of base stations is two (for example, the candidate positions 401a and 401b of the base stations and the candidate position 501a of the relay station in FIG. 5).

By the processing described with reference to FIG. 2 to 6, the radio zone design apparatus 100 according to the present embodiment can perform radio zone design method satisfying a necessary communication request at low cost by combining the base station and the relay station.

### <First Selection Processing>

Next, an example of the first selection processing executed by the first selection unit 104 will be described by exemplifying a plurality of examples.

### Example 11

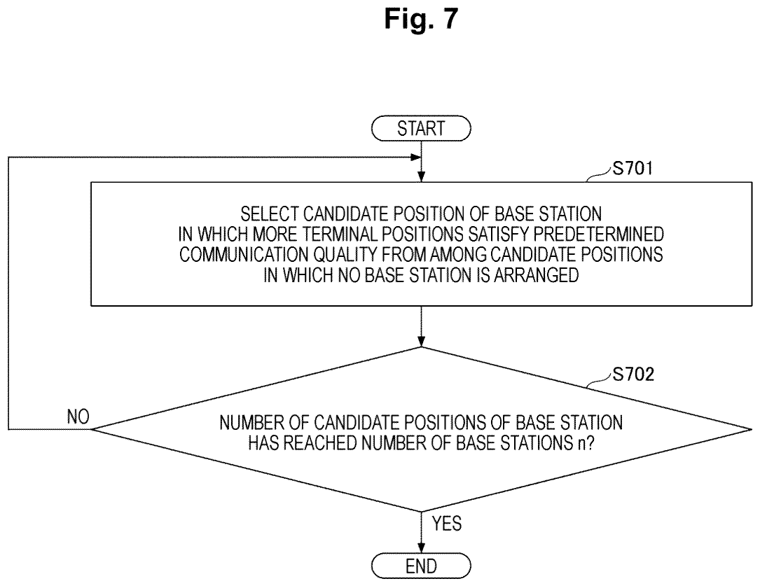

FIG. 7 is a flowchart illustrating an example of the first selection processing according to Example 1. This processing illustrates an example of the first selection processing executed by the first selection unit 104 of the radio zone design apparatus 100 in step S205 in FIG. 2, for example.

In step S701, the first selection unit 104 selects a candidate position of the base station in which more terminal positions 302 satisfy a predetermined communication quality from among the candidate positions 303 in which no base station is arranged.

In step S702, the first selection unit 104 determines whether or not the number of candidate positions of the base station selected has reached the number of base stations n. In a case where the number of candidate positions of the base station has not reached the number of base stations n, the first selection unit 104 returns the processing to step S701. On the other hand, in a case where the number of candidate positions of the base station has reached the number of base stations n, the first selection unit 104 ends the processing in FIG. 7.

In this manner, the first selection unit 104 may select the candidate position of the base station of the number of base stations n by selecting the candidate position of the base station 303 in which more terminal positions 302 satisfy a required communication quality by, for example, a greedy algorithm until the number of base stations n is reached.

### Example 2

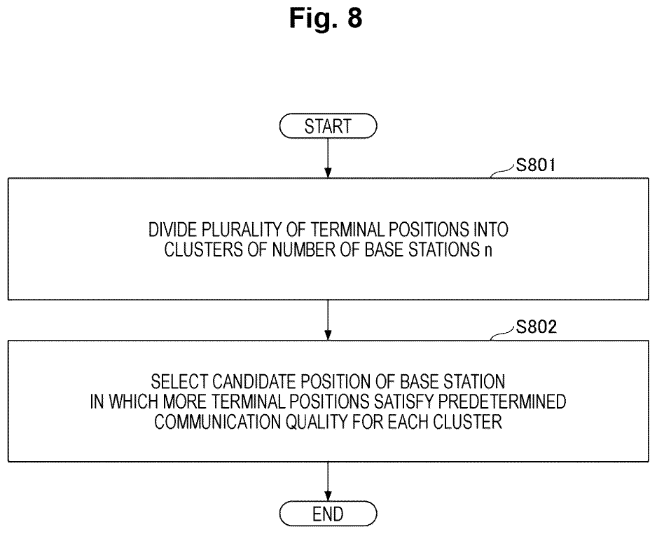

FIG. 8 is a flowchart illustrating an example of the first selection processing according to Example 2. This processing illustrates another example of the first selection processing executed by the first selection unit 104 of the radio zone design apparatus 100 in step S205 in FIG. 2, for example.

In step S801, the first selection unit 104 divides the plurality of terminal positions 302 into clusters of the number of base stations n. As an example, the first selection unit 104 divides the plurality of terminal positions 302 into the clusters of the number of base stations n by using a known clustering method such as a k-means clustering. Note that the clustering method is not limited to the k-means clustering, and non-hierarchical and hierarchical clustering methods can be applied.

In step S802, the first selection unit 104 selects the candidate position 303 of the base station in which more terminal positions 302 satisfy a predetermined communication quality for each divided cluster.

In this manner, for example, the first selection unit 104 may divide the plurality of terminal positions 302 into the clusters of the number of base stations n, and select the candidate position 303 of the base station in which a required communication quality is satisfied at more terminal positions 302 for each cluster.

Although the radio zone design apparatus 100 and the radio zone design method according to the present embodiment have been described above, the radio zone design apparatus 100 and the radio zone design method according to the present invention can be variously modified and applied.

For example, in each of the above descriptions, it has been described that the plurality of candidate positions 303 are positions (coordinates) of the base stations or the relay stations, but the plurality of candidate positions 303 may be represented by combinations of the position of the base station or the relay station and an installation direction (or an orientation of an antenna, or the like).

In addition, although the description has been made assuming a single wireless communication scheme so far, a plurality of wireless communication schemes may be used in combination that differ for each base station or differ between the base station and the relay station. Note that, in that case, fair evaluation across wireless communication schemes cannot be made with the reception power, and thus the radio zone design apparatus 100 may perform communication quality evaluation after performing conversion into a comparable index such as a wireless transmission rate expected value.

Further, the description has been made without considering isolation in the relay station so far. However, not limited thereto, in step S207 in FIG. 2, when selecting a candidate position of a relay station, the radio zone design apparatus 100 may select a candidate position of the relay station after setting a difference condition between a relay reception direction and a relay transmission direction in the relay station. Note that it is generally known that isolation between transmission and reception is important in a case where reception and relay transmission are performed simultaneously although it depends on a relay scheme. As an example of condition setting of isolation, for example, an angle in a transmission/reception direction and the like can be considered.

Furthermore, in steps S204 to S209 in FIG. 2, the radio zone design apparatus 100 acquires radio zone design method evaluation results in a general way while increasing the number of base stations within a range designated in advance, and then determines the radio zone design method from among them. However, not limited thereto, the radio zone design apparatus 100 may acquire a radio zone design method evaluation result each time while increasing the number of base stations, and, if there is a radio zone design method evaluation result satisfying all conditions determined in advance, set the radio zone design method result as a final solution, and terminate the subsequent arithmetic processing.

### Hardware Configuration Example

### (Hardware Configuration of Radio Zone Design Apparatus)

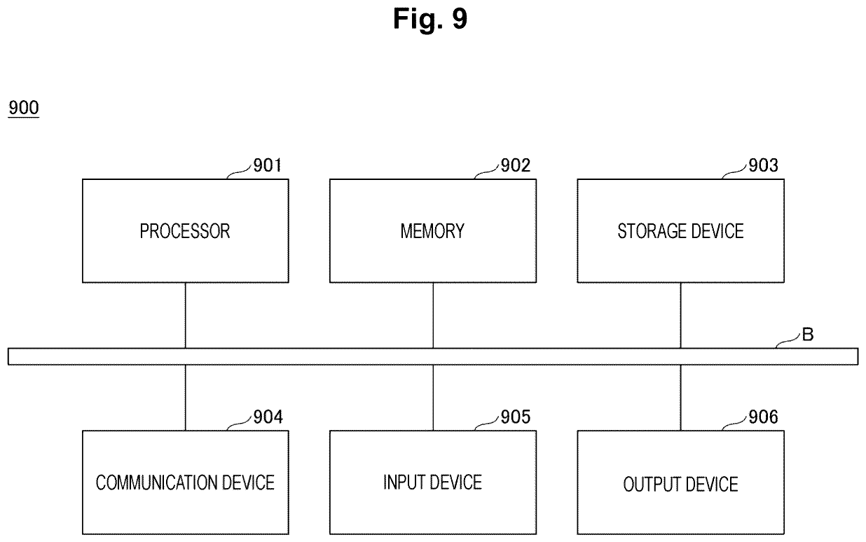

FIG. 9 is a diagram illustrating an example of a hardware configuration of the radio zone design apparatus according to the present embodiment. The radio zone design apparatus 100 has, for example, a hardware configuration of a computer 900 as illustrated in FIG. 9. In the example of FIG. 9, the computer 900 includes a processor 901, a memory 902, a storage device 903, a communication device 904, an input device 905, an output device 906, a bus B, and the like.

The processor 901 is, for example, an arithmetic device such as a central processing unit (CPU) that implements various functions by executing a predetermined program. The memory 902 is a storage medium readable by the computer 900, and includes, for example, a random access memory (RAM) or a read only memory (ROM). The storage device 903 is a computer-readable storage medium, and can include, for example, a hard disk drive (HDD), a solid state drive (SSD), various optical discs, and a magneto-optical disk.

The communication device 904 includes one or more pieces of hardware (communication devices) for communicating with other devices via a wireless or wired network. The input device 905 is an input device (for example, a keyboard, a mouse, a microphone, a switch, a button, or a sensor) that receives an input from the outside. The output device 906 is an output device (for example, a display, a speaker, or an LED lamp) that performs output to the outside. Note that the input device 905 and the output device 906 may be integrated (for example, an input/output device such as a touch panel display).

The bus B is commonly connected to the above-described components, and transmits, for example, an address signal, a data signal, and various control signals. Note that the processor 901 is not limited to a CPU, and may be, for example, a digital signal processor (DSP), a programmable logic device (PLD), or a field programmable gate array (FPGA).

### (Supplement)

The radio zone design apparatus 100 in the present embodiment is not limited to implementation by a dedicated device, and may be implemented by a general-purpose computer. In that case, a program for implementing the functions may be recorded in a computer-readable recording medium, and the functions may be implemented by loading the program recorded in this recording medium to a computer system, and executing the program. Note that, the “computer system” referred to herein includes an OS and hardware such as peripheral devices.

In addition, the “computer-readable recording medium” includes various storage devices such as a portable medium such as a flexible disk, a magneto-optical disk, a ROM, and a CD-ROM, and a hard disk built into a computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case.

In addition, the program may be for implementing some of the above-described functions, may be capable of implementing the above-described functions in combination with a program already recorded in a computer system, or may be implemented by using hardware such as a programmable logic device (PLD) or a field programmable gate array (FPGA).

### Effects of Embodiment

According to the present embodiment, it becomes possible to perform radio zone design method satisfying a necessary communication request at low cost by combining the base station and the relay station.

### Summary of Embodiment

The present specification discloses at least the following radio zone design apparatus, radio zone design method, and program.

### (Clause 1)

A radio zone design apparatus for designing installation positions of a base station and a relay station for constructing a wireless area, the radio zone design apparatus including:
an arrangement unit configured to arrange a plurality of terminal positions and a plurality of candidate positions, the plurality of terminal positions being evaluation points, and the plurality of candidate positions being candidates for an installation position of the base station or the relay station in the wireless area including a shielding object;
a calculation unit configured to calculate reception power between each of the terminal positions and a corresponding one of the candidate positions, and reception power between each of the candidate positions and each of other candidate positions;
a first selection unit configured to select, for each of different numbers of base stations, a candidate position of the base station for a corresponding number of base stations from among the plurality of candidate positions;
a second selection unit configured to select, in a case where there is a terminal position that is not able to be accommodated by the candidate position of the base station among the plurality of terminal positions, a candidate position of the relay station capable of accommodating, in combination with the candidate position of the base station, the terminal position that is not able to be accommodated; and
a determination unit configured to determine installation positions of the base station and the relay station in which a cost of the wireless area is minimized from among candidate positions of the base station or combinations of the candidate position of the base station and the candidate position of the relay station.

### (Clause 2)

The radio zone design apparatus according to clause 1, in which the first selection unit divides the plurality of terminal positions into clusters of the number of base stations, and selects, for each of the clusters, the candidate position of the base station in which more terminal positions satisfy a predetermined communication quality.

### (Clause 3)

The radio zone design apparatus according to clause 1, in which the first selection unit selects the candidate position of the base station in order from the candidate position of the base station in which more terminal positions satisfy a predetermined communication quality until the number of base stations is reached.

### (Clause 4)

The radio zone design apparatus according to any one of clauses 1 to 3, in which the second selection unit
extracts the candidate position of the relay station capable of accommodating the terminal position that is not able to be accommodated from among candidate positions excluding the candidate position of the base station among the plurality of candidate positions, and
selects, from among candidate positions of the relay station extracted, a candidate position of the relay station in which reception power from the candidate position of the base station is greater than or equal to a predetermined value.

### (Clause 5)

A radio zone design method executed by a radio zone design apparatus for designing installation positions of a base station and a relay station for constructing a wireless area, the radio zone design method including:
arrangement processing of arranging a plurality of terminal positions and a plurality of candidate positions, the plurality of terminal positions being evaluation points, and the plurality of candidate positions being candidates for an installation position of the base station or the relay station in the wireless area including a shielding object;
calculation processing of calculating reception power between each of the terminal positions and a corresponding one of the candidate positions, and reception power between each of the candidate positions and a corresponding one of other candidate positions;
first selection processing of selecting, for each of different numbers of base stations, a candidate position of the base station for a corresponding number of base stations from among the plurality of candidate positions;
second selection processing of selecting, in a case where there is a terminal position that is not able to be accommodated by the candidate position of the base station among the plurality of terminal positions, a candidate position of the relay station capable of accommodating, in combination with the candidate position of the base station, the terminal position that is not able to be accommodated; and
determination processing of determining installation positions of the base station and the relay station in which a cost of the wireless area is minimized from among candidate positions of the base station or combinations of the candidate position of the base station and the candidate position of the relay station.

### (Clause 6)

A program for causing a computer to execute the radio zone design method according to clause 5.

The present embodiment has been described above; however, the present invention is not limited to such a specific embodiment, and various modifications and changes can be made within the scope of the gist of the present invention described in the claims.

Reference Signs List

| | |
|---|---|
| 100 | Radio zone design apparatus |
| 102 | Arrangement unit |
| 103 | Calculation unit |
| 104 | First selection unit |
| 105 | Second selection unit |
| 106 | Determination unit |
| 300 | Wireless area |
| 301 | Shielding object |
| 302 | Terminal position |
| 303 | Candidate position |
| 900 | Computer |

1. A radio zone design apparatus for designing installation positions of a base station and a relay station for constructing a wireless area, the radio zone design apparatus comprising:
a processor; and
a memory storing instructions that cause the processor to execute a process, the process including
arranging a plurality of terminal positions and a plurality of candidate positions, the plurality of terminal positions being evaluation points, and the plurality of candidate positions being candidates for an installation position of the base station or the relay station in the wireless area including a shielding object;
calculating reception power between each of the terminal positions and a corresponding one of the candidate positions, and reception power between each of the candidate positions and a corresponding one of other candidate positions;
selecting, for each of different numbers of base stations, a candidate position of the base station for a corresponding number of base stations from among the plurality of candidate positions;
selecting, in a case where there is a terminal position that is not able to be accommodated by the candidate position of the base station among the plurality of terminal positions, a candidate position of the relay station capable of accommodating, in combination with the candidate position of the base station, the terminal position that is not able to be accommodated; and
determining installation positions of the base station and the relay station in which a cost of the wireless area is minimized from among candidate positions of the base station or combinations of the candidate position of the base station and the candidate position of the relay station.

2. The radio zone design apparatus according to claim 1, wherein the plurality of terminal positions are divided into clusters of the number of base stations, and the candidate position of the base station in which more terminal positions satisfy a predetermined communication quality is selected, for each of the clusters.

3. The radio zone design apparatus according to claim 1, wherein the candidate position of the base station is selected in order from the candidate position of the base station in which more terminal positions satisfy a predetermined communication quality until the number of base stations is reached.

4. The radio zone design apparatus according to claim 1, wherein
the candidate position of the relay station capable of accommodating the terminal position that is not able to be accommodated is extracted from among candidate positions excluding the candidate position of the base station among the plurality of candidate positions, and
a candidate position of the relay station in which reception power from the candidate position of the base station is greater than or equal to a predetermined value is selected from among candidate positions of the relay station extracted.

5. A radio zone design method executed by a radio zone design apparatus for designing installation positions of a base station and a relay station for constructing a wireless area, the radio zone design method comprising:
arranging a plurality of terminal positions and a plurality of candidate positions, the plurality of terminal positions being evaluation points, and the plurality of candidate positions being candidates for an installation position of the base station or the relay station in the wireless area including a shielding object;
calculating reception power between each of the terminal positions and a corresponding one of the candidate positions, and reception power between each of the candidate positions and a corresponding one of other candidate positions;
selecting, for each of different numbers of base stations, a candidate position of the base station for a corresponding number of base stations from among the plurality of candidate positions;
selecting, in a case where there is a terminal position that is not able to be accommodated by the candidate position of the base station among the plurality of terminal positions, a candidate position of the relay station capable of accommodating, in combination with the candidate position of the base station, the terminal position that is not able to be accommodated; and
determining installation positions of the base station and the relay station in which a cost of the wireless area is minimized from among candidate positions of the base station or combinations of the candidate position of the base station and the candidate position of the relay station.

6. A non-transitory computer-readable recording medium having computer-readable instructions stored thereon, which when executed, cause a computer to execute the radio zone design method according to claim 5.
